(19) United States
(12) Patent Application Publication
(10) Pub. No.: US 2008/0051135 A1
(43) Pub. Date: Feb. 28, 2008

(54) COMBINATION CAMERA/PROJECTOR SYSTEM

(75) Inventors: Patrick R. Destain, Allen, TX (US); John E. Duncan, Amelia, OH (US); Michael W. O'Keefe, Cincinnati, OH (US); Jennifer L. Grace, Lakeside Park, KY (US); William E. Phillips III, Cincinnati, OH (US); Stephen J. Willett, Saint Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/831,220

(22) Filed: Jul. 31, 2007

Related U.S. Application Data
(60) Provisional application No. 60/820,877, filed on Jul. 31, 2006.

(51) Int. Cl. H04M 1/00

(52) U.S. Cl. 455/556.1

(57) ABSTRACT

A combination camera/projection system includes an image forming device, a light source, a projection lens, a detector array such as a CCD, and a beam splitter such as a polarizing beam splitter (PBS) disposed to direct light from the light source to the image forming device, and from the image forming device to the projection lens, and from the projection lens to the detector array.

### CROSS-REFERENCE TO RELATED APPLICATION

The present application is based on and claims the benefit of U.S. provisional patent application Ser. No. 60/820,877, filed Jul. 31, 2006, the content of which is hereby incorporated by reference in its entirety.

Reference is made to commonly assigned U.S. patent application entitled “LED Mosaic” (Attorney Docket No. 62370US006), filed on even date herewith; U.S. patent application entitled “LED Source With Hollow Collection Lens” (Attorney Docket No. 62371US006), filed on even date herewith; U.S. patent application entitled “Integrating Light Source Module” (Attorney Docket No. 62382US008), filed on even date herewith; U.S. patent application entitled “Optical Projection Subsystem” (Attorney Docket No. 63281US002), filed on even date herewith; US Patent Publication US 2007/0152231, “LED With Compound Encapsulant Lens”; US Patent Publication US 2007/0023941 A1 Duncan et al.; US Patent Publication US 2007/0024981 A1 Duncan et al.; US Patent Publication US 2007/0085973 A1 Duncan et al.; and US Patent Publication US 2007/0030456 Duncan et al., all incorporated herein by reference.

### BACKGROUND

Increasingly, many mobile electronics devices include displays for displaying information, pictures, videos and the like. For example, mobile phones, personal digital assistants (PDAs), navigation aiding devices and other types of personal mobile electronics include such displays. While useful, the relatively small size of these displays limits their ability to be viewed for certain purposes, particularly by multiple individuals simultaneously.

An optical projector can be a more practical device for facilitating the viewing of certain types of information due to the ability to display an enlarged image relative to a small display. This is particularly true when it is desirable for multiple individuals to view the information simultaneously. Optical projectors are used to project images onto surfaces for viewing by groups of people. Optical projectors include optical projector subsystems that include lenses, filters, polarizers, light sources, image forming devices and the like. Fixed front and rear electronic projectors are known for use in education, home theatres and business meeting use. For mobile applications, there is a desire to miniaturize optical projectors both in terms of volume and thickness and to make them extremely power efficient while maintaining low power consumption, low cost and high image quality.

Many mobile electronic devices, such as mobile phones, include a built-in camera. This typically requires that the mobile electronic device include at least some sort of lens or lens assembly for collecting light of an image to be captured, an image sensor such as a charge coupled device (CCD) or a complementary metal-oxide-semiconductor (CMOS) device. The quality of the camera provided in these mobile electronic devices is often not high, due at least in part to a desire to keep the costs of the devices as low as possible. Attempts have been made to introduce both cameras and optical projectors into mobile phones or other mobile electronic devices. In many instances, success of such an attempt can be dependent on cost, camera and projector quality, size, or a combination of these factors.

The discussion above is merely provided for general background information and is not intended to be used as an aid in determining the scope of the claimed subject matter.

### SUMMARY

A combination camera/projection system includes an image forming device, a light source, a projection lens, a detector array such as a CCD, and a beam splitter such as a polarizing beam splitter (PBS) disposed to direct light from the light source to the image forming device, and from the image forming device to the projection lens, and from the projection lens to the detector array.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1A is a schematic illustration of a combination camera/projector system.

FIG. 1B is a schematic illustration of an alternate combination camera/projector system.

FIG. 1C is a schematic illustration of an alternate combination camera/projector system.

FIG. 2 is a schematic illustration of a combination camera/projector system comprising additional features.

FIG. 3A is a schematic illustration of a combination camera/projector system in projection mode.

FIG. 3B is a schematic illustration of the combination camera/projector system of FIG. 3A, but in camera mode.

FIG. 4 is a flow diagram illustrating a method of controlling an image projection system.

### DETAILED DESCRIPTION

Disclosed embodiments include combination camera/projection systems which are compact and well suited for use in personal electronic devices such as mobile phones, PDAs, digital cameras, digital video cameras, etc. In these embodiments, a projection lens and a beam splitter each are used for dual purposes—to project light in a projection mode and to receive light for imaging to a camera or other light-receiving device in a camera or image detecting mode. The beam splitter, which is in an exemplary embodiment a polarizing beam splitter (PBS), acts as a light router, passing light for projection, and reflecting light to a sensor array, such as a charge-coupled device (CCD) or complementary metal oxide semiconductor (CMOS), within a cell phone, camera, or similar compact device. Alternatively, the beam splitter can reflect light for projection, and pass light to the sensor array. In either case, for a particular configuration, movement of the beam splitter is not necessary to change between these modes of operation. Also, the same configuration can be used to reflect a signal (such as infrared) from the projected surface to a sensor and to tie this electronically to an auto-focus function within the projection unit. Here, the “projected surface” refers to a screen or other object external to the projection system on which the projected light falls.

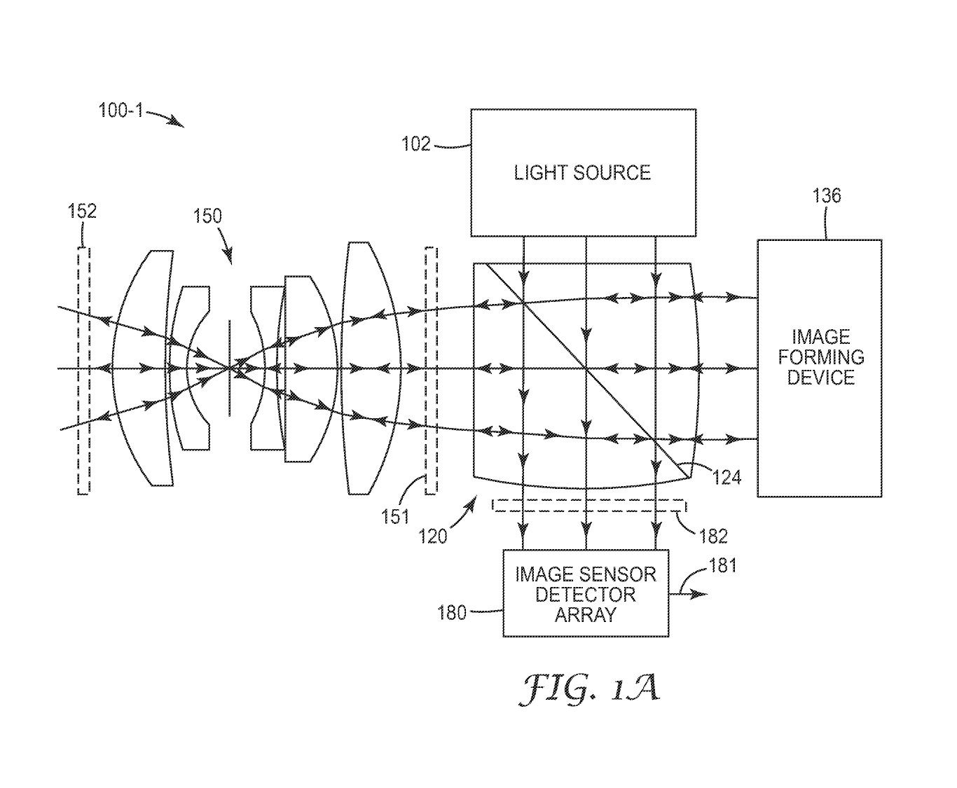

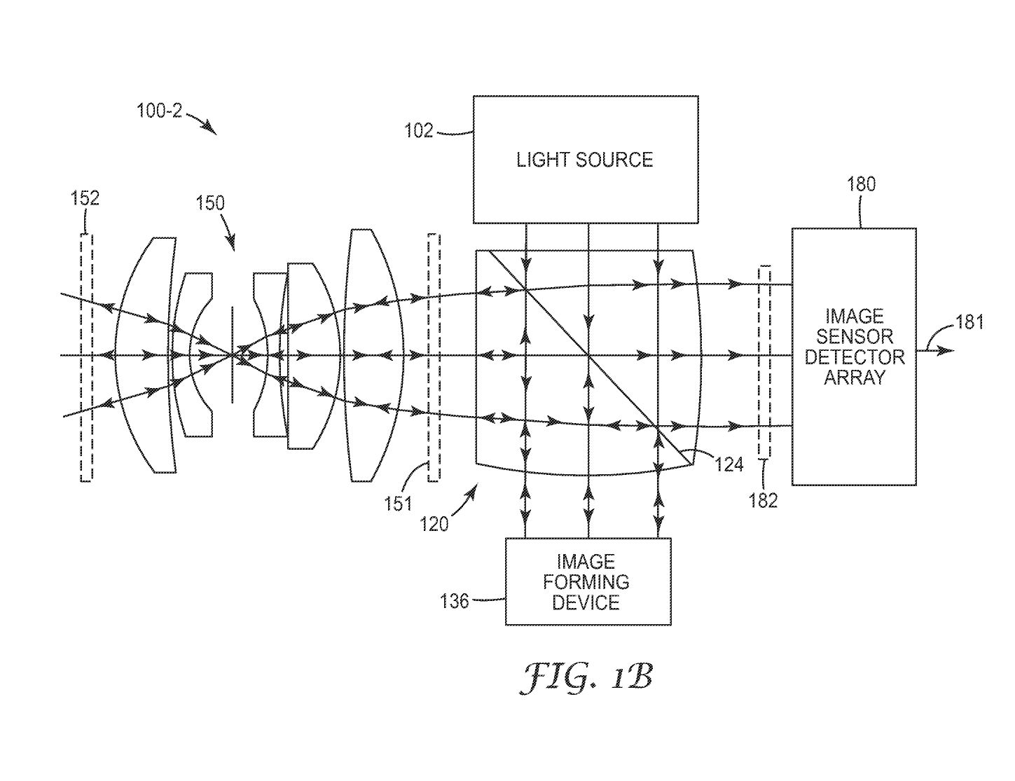

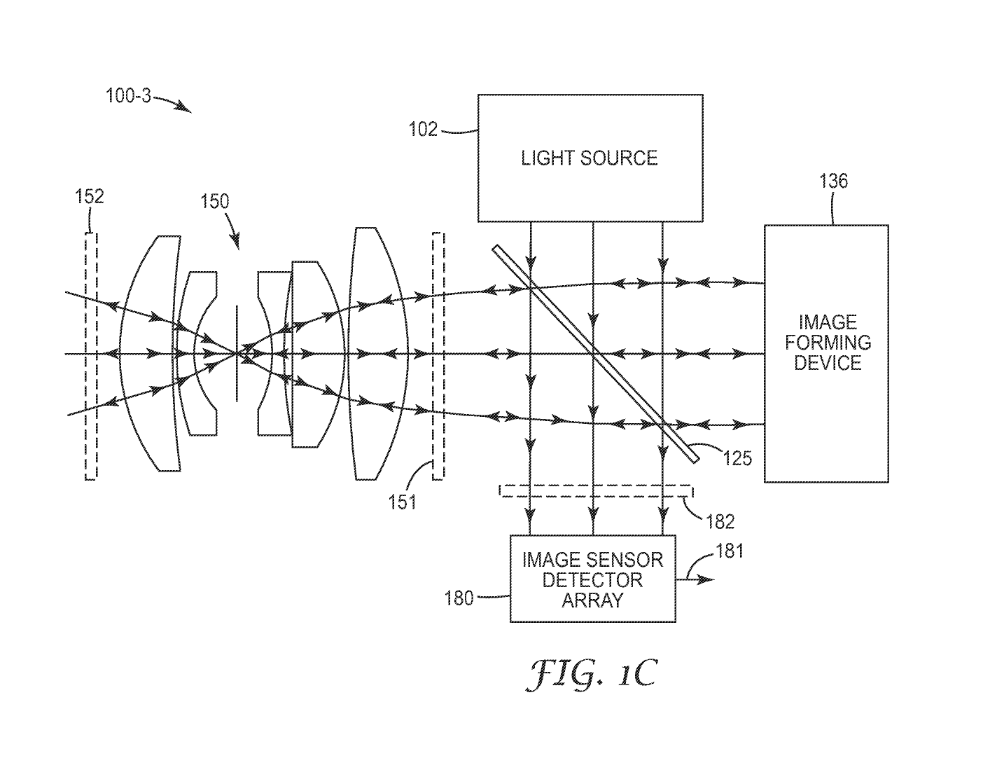

Referring now to FIG. 1A, shown is an exemplary dual projector/camera system 100-1. The system 100-1 includes a light source 102, such as disclosed in U.S. application Ser. No. 11/322,801, “LED With Compound Encapsulant Lens”, filed Dec. 30, 2005; or in U.S. application entitled “LED Source With Hollow Collection Lens” (Attorney Docket No. 62371US006), filed on even date herewith, both incorporated herein by reference. In various embodiments, light source 102 can be a laser cavity light source, an LED, an array of LEDs, or an LED including a microstructure such as a photonic crystal.

The system also includes a digital imaging device (image forming device) 136, such as a liquid crystal on silicon (LCOS) panel, for forming an image that will be projected. The digital imaging device 136, which is part of the projection function of the system, produces a 2-dimensional pixellated image in response to a digital input/control signal. The LCOS device is in some embodiments a ferro-electric LCOS device. Also, in some embodiments, the LCOS device includes built-in color filters. The system also includes a detector array 180, such as a charge-coupled device (CCD) or complementary metal oxide semiconductor (CMOS) detector. In contrast to the digital imaging device 136, the detector array 180 (which is part of the camera function of the system) produces an output signal 181 as a function of the light incident on the detector array from an object or scene external to the system.

On the left side of the figure is a collection of lens elements (five in the illustrated embodiment, but other arrangements can also be used) that form a projection lens 150. The projection lens is used to both project light originating from the light source 102 and reflecting off the digital imaging device 136 to an external screen, and to collect light from an object or scene and help focus that light onto the detector array 180.

A beam splitter 120, in exemplary embodiments a polarizing beam splitter (PBS), is disposed between the other components as shown to split the light paths between the projection system and the camera system. The beam splitter 120 may be a cube-like transparent solid with an embedded diagonal beam splitting surface 124, as shown in FIG. 1A. Exemplary polarizing beam splitters fabricated from optical plastic for 120 and multilayer polymeric optical film for 124 are disclosed in commonly assigned US Patent Publication US 2007/0023941 A1 Duncan et al.; US Patent Publication US 2007/0024981 A1 Duncan et al.; US Patent Publication US 2007/0085973 A1 Duncan et al.; and US Patent Publication US 2007/0030456 Duncan et al., all incorporated herein by reference. Curved surfaces can be used on the beam splitter to provide additional optical power or for aberration control in either or both the projection system and the camera system, depending on which surfaces are curved. In fact, since two external surfaces of the beam splitter 120 are used exclusively by the projection system, and a different external surface is used exclusively by the camera system, curvatures can be provided that provide different magnifications for the projection subsystem compared to the camera subsystem. For example, for a field-of-view of about 50 degrees, the projection subsystem may have a magnification of 20×, and the camera subsystem may have a magnification of 40×. The beam splitter 120 can be made of any suitable high quality light transmissive material, such as plastic or glass. Furthermore, the system is compatible with any MacNeille-type PBS. This system is also compatible with a cholesteric reflective polarizer type of PBS.

Alternatively, the beam splitter may consist entirely of a beam splitting plate 125 situated diagonally in air and physically supported and maintained in that diagonal position. This is illustrated, for example, in system 100-3 shown in FIG. 1C. With the exception of using a beam splitting plate 125 instead of a beam splitting cube 120, systems 100-1 and 100-3 can be identical. For embodiments in which polarization splitting is desired, an example of such a beam splitting plate 125 is wire-grid reflective polarizer (such as those manufactured by Moxtek, Inc., Orem Utah) or any grating polarizer beam splitter. Another example of a beam splitting plate 125 is a multilayer optical film reflecting polarizer manufactured by 3M Corporation, St. Paul, Minn., such as those described in Jonza et al., U.S. Pat. No. 5,882,774; Weber et al., U.S. Pat. No. 6,609,795; and Magarill et al., U.S. Pat. No. 6,719,426, the disclosures of which are hereby incorporated by reference. Such a multilayer optical film reflecting polarizer may optionally be supported by a planar transparent substrate. In the case when a beam splitting plate 125 is used, system 100-3 may also include lenses or other optical elements between plate 125 and elements 180 and 136.

Referring back to FIG. 1A, in operation, while system 100-1 is in the projection mode, light source 102 provides an output light in the direction of PBS 120. In various embodiments, the light can be pre-polarized light (all having a predetermined polarization state) that will preferably be directed to the image forming device 136 by the PBS 120, or unpolarized light (light having all polarization states), as will be described later in greater detail. In exemplary embodiments, the light provided by light source 102 is collimated in the direction of PBS 120. As light hits diagonally oriented reflective polarizer 124 of PBS 120, light having a first polarization state is transmitted through polarizer 124 toward detector array 180. Light having a second polarization state reflects off of polarizer 124 toward image forming device 136, which in exemplary embodiments is a LCOS device.

The polarized light that heads toward the LCOS imager 136 reflects at substantially normal incidence. The LCOS imager uses individual pixels to rotate the plane of polarization of the light by differing amounts depending what is to be displayed on those individual pixels. The light of the second polarization state that had been reflected by the reflective polarizer 124 toward the LCOS 136 will again be reflected by the reflective polarizer 124 back toward the light source 102. That generally corresponds to the pixels that are to be dark. For light pixels, in which the LCOS imager 136 has changed the polarization to the first state, the light is now transmitted through the reflective polarizer 124 of the PBS, and out through the projection lens 150 and onto a screen or whatever surface is being used for projection. For pixels intended to be in an intermediate state between light and dark, the LCOS partially rotates the reflected light from the second to the first polarization state, so that a fraction of the light reflected from the imager 136 is transmitted through the reflective polarizer 124 and out through the projection lens 150.

In camera or image detecting mode of operation of system 100-1, light source 102 can be turned off to save power. Light corresponding to an image to be captured enters projection lens 150 and is directed toward reflective polarizer 124 of PBS 120. As light hits diagonally oriented reflective polarizer 124, light having the first polarization state is transmitted through polarizer 124 toward image forming device 136 where it can be disregarded. Light having the second polarization state reflects off polarizer 124 toward detector array 180, which captures the image by generating electrical signals representative thereof.

It is well known for photographers to use a polarizing filter over the lens of a conventional camera, in order to enhance or suppress elements within the photographic composition whose light arrives at the camera lens at least partially polarized. Such sources of (partially) polarized light might include blue sky, rainbows, and reflections off non-metallic surfaces such as water or glass. Photographers can control the degree of enhancement or suppression by varying the angle of the polarizing filter. In embodiments of the present invention in which the beam splitter 120 is a PBS, the beam splitting surface 124 is a polarizer that can act in similar fashion to a conventional camera polarizing filter. In the present invention, to make the polarization acceptance from the scene a controllable feature of the camera, the lens system may optionally include a quarter-wave retarder in the path of incoming light before the beam splitter 120, either in position 151 or 152 of FIG. 1A. The rotation angle of this quarter-wave retarder could also be made optionally variable by the user, in order to have photographic control similar to rotating the polarizing filter in a conventional camera. The presence of this quarter-wave retarder, regardless of rotation angle, will not significantly affect projected images from the digital imaging device 136 while the system 100-1 is in projection mode.

In embodiments of the present invention in which the beam splitter 120 is a PBS, an optional polarizer 182, of either the absorbing or reflecting type, can be added to system 100-1 between sensor array 180 and polarizer 124, such that it passes the second state (as previously defined with reference to polarizer 124) of polarization. Polarizer 182 may be useful to protect sensor array 180 from prolonged or intense exposure to residual light of the first polarization state that may emerge from light source 102 and pass through polarizer 124 during operation of system 100-1 in projection mode. Polarizer 182 may be especially useful in cases when the projection and camera modes are operating simultaneously, as described below, in which polarizer 182 will help suppress unwanted light on the sensor array 180 and increase the contrast of the detected image entering projection lens 150 and reflecting off polarizer 124.

It is noteworthy to mention that system 100-1 is capable of separating light between the projection system and the camera system without the need for moving parts, due to the efficient light separation provided by the (static) PBS 120. Note also that the beam splitter 120 separates light between these two channels simultaneously.

For systems designed for use in physically small packages, such as a mobile phone, the various system components, including the projection lens, can have a transverse dimension or size that is within a factor of two times the transverse dimension of the digital imaging device, and more desirably in some embodiments about the same size as (or less than) the transverse dimension of the digital imaging device. Note that folding mirrors can be utilized in the disclosed camera/projector systems, and indeed in standalone camera systems and standalone projector systems, to further reduce system size or volume.

As mentioned, in alternative embodiments, the beam splitter 120 can reflect light for projection, and pass light to the sensor array. This is illustrated for example in FIG. 1B showing a system 100-2 which functions very similarly to system 100-1. Here, in projection mode light from source 102 which is initially transmitted through the reflective polarizer 124 strikes LCOS image forming device 136. Also, light corresponding to pixels of LCOS imaging forming device 136 in which the polarization state is changed is now reflected by reflective polarizer 124 out through projection lens 150. Light reflected from device 136 in which the polarization state does not change is now transmitted through reflective polarizer 124 back toward light source 102. Light from source 102 which is initially reflected by reflective polarizer 124 is directed toward detector array 180 where it can be disregarded. In camera mode, light collected by lens 150 which has a polarization state transmitted by reflective polarizer 124 strikes detector array 180 for image capture, while light from lens 150 which is reflected by reflective polarizer 124 is directed toward image forming device 136 wherein it can be disregarded. It must be understood that all features disclosed in various embodiments of various FIGS. can be utilized in other embodiments as well. For example, the embodiment shown in FIG. 1C in which the image forming device 136 and the detector array 180 are in alternate positions should be interpreted as also optionally covering embodiments having this arrangement, but in which a beam splitting plate 125 (shown in FIG. 1C) is used. Likewise, features disclosed below (e.g., auto-focus, screen compensation, etc.) can all be used with any of the disclosed configurations, even though these features are illustrated with one particular configuration.

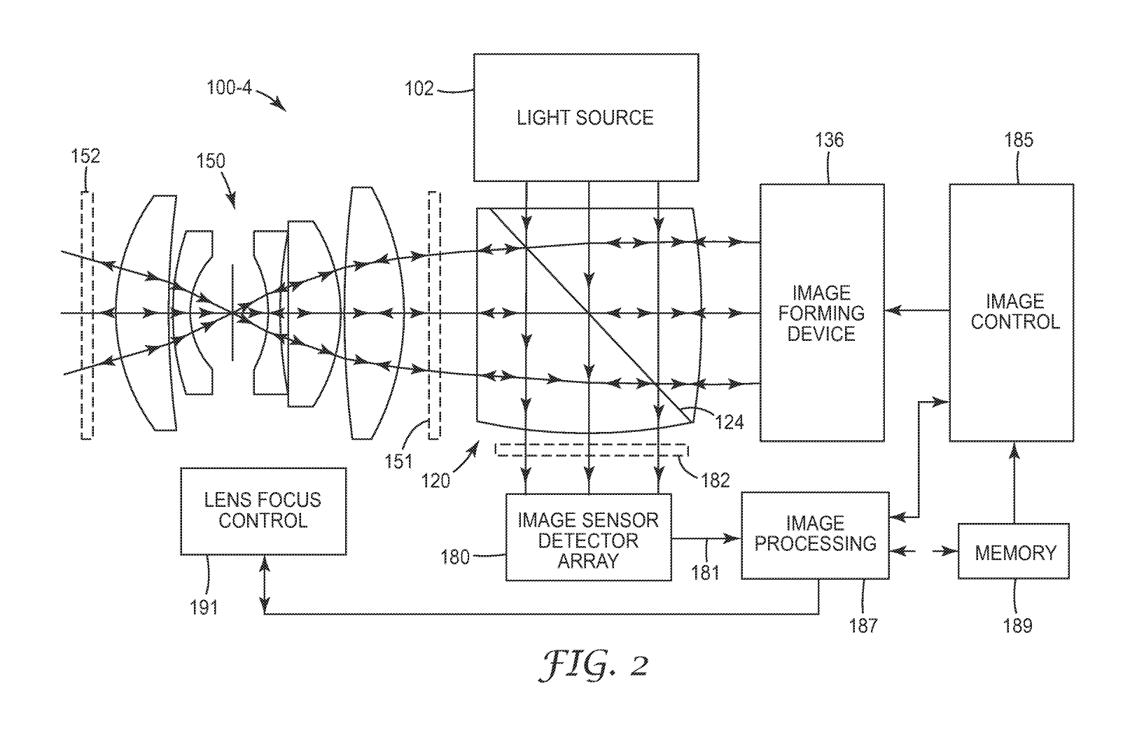

Referring now to FIG. 2, shown is a dual projector/camera system 100-4 which optionally includes other features and components, for example relating to auto-focus functions of the system. The additional components shown in FIG. 2 are optional, and need not all be present in the form or combination illustrated. As shown in FIG. 2, image control circuitry 185 is included to provide image data to image forming device 136. The image forming data can include, for example, the pixel control data for sequentially or otherwise addressing individual pixels to form images. Also included is image processing circuitry 187 coupled to detector array 180. Image processing circuitry 187 can be digital image processing circuitry for conditioning, evaluating or otherwise processing image data provided by array 180. Image processing circuitry 187 can also receive and process an image or a signal indicative of a surface. Memory 189 can also be included for storing images detected by array 180 and processed by circuitry 187, or for storing video or still frame images to be projected by system 100-4 under the control of circuitry 185.

In an exemplary embodiment, system 100-4 also includes lens focus control 191 for controlling the focus of lens 150. Lens focus control 191 includes, in exemplary embodiments, circuitry and one or more electromechanical actuators for changing the focus provided by the lenses of projection lens 150. Using this lens focus control, detector array can capture an image, and image processing circuitry 187 can utilize any of a variety of algorithms to analyze the image to determine if the image is in proper focus. If the image is not in proper focus, image processing circuitry 187 can communicate with lens focus control 191 to adjust the focus of lens 150 until the image is in the desired focus. This mechanism of feedback focus control can be used to adjust the focus of lens 150 at desired times (for example in response to a user input), continuously, semi-continuously, or at other times or intervals.

In another exemplary embodiment, proper focus may be determined by detection of a signal (such as infrared) sent by the electronic device in which the camera/projector system is incorporated. The signal is reflected from the projected surface (screen), passes through lens assembly 150, is reflected by beam splitter 124 (which has been designed to reflect at the wavelength of the signal), and is detected by a sensor at position 180. In this embodiment, the sensor might be a single detector element instead of an array. Lens focus control 191 and image processing circuitry 187 include, in this exemplary embodiment, circuitry to detect the distance to the screen from the transit time of the signal to and from the screen, and one or more electromechanical actuators for changing the focus provided by the lenses of projection lens 150.

In one more particular embodiment, the image captured by array 180 and analyzed by image processing circuitry 187 corresponds to a projected image originating from image forming device 136 under the control of image control circuitry 185. In this embodiment, the above-described auto-focus techniques are used to focus the projected image so that it is in proper focus on the projection surface. Control of lens focus control 191 can be from image control circuitry 185 instead of image processing circuitry 187. Also, in some embodiments, based upon the image processing of the detected image performed by circuitry 187, image control 185 can control the image forming device to adjust contrast, brightness or other image quality characteristics.

Additional desirable features can be enabled by operating the camera function simultaneously with the projection function. For example, a user could use a pointing device, such as commonly available red or green laser diodes, to point to a location in the projected image. Simultaneous to the projection of the image, the camera could detect the complete image on the screen (both projected from the image forming device 136 and from the pointing device). Image processing circuitry 187 could compare the image sent from image control circuitry 185 to the image detected by the detector array 180, adjusting the size as necessary to get proper pixel correspondence, and identify which location on the image from the image forming device 136 is being selected by the pointer. This information can then be used as input to determine further images for projection, or other user-interactive, software-controlled actions of the electronic device to which the camera/projector is attached or in which it is embedded.

Another desirable feature that can be enabled by operating the camera function in conjunction with the projection function would be dynamic compensation in the projected image. For example, if the screen on which the image is projected is tinted a color other than white, image processing circuitry 187 could compare the image sent from the image control circuitry 185 to the image detected by the detector array 180, adjusting the size of the images as necessary to get proper pixel correspondence, and identify the overall tint of the screen. The electronics and software could then be set to compensate for that tint in the image data files that are sent by the image control circuitry 185 to the image forming device 136, so that the final image seen on the screen by the viewer corrects for the undesirable tint of the screen.

The process described in the preceding paragraph can be considered a global correction of the entire image. This process could also be extended and applied on a pixel-by-pixel basis within the image. For example, the screen may have two or more tinted regions, or a gradient in tint and hue, or even a more detailed pattern such as wallpaper might exhibit. In such cases the image processing circuitry 187 could compare the image sent from the image control circuitry 185 to the image detected by the detector array 180, adjusting the size of the images as necessary to get proper pixel correspondence, and then make an intensity/tint/hue correction on a pixel-by-pixel basis in the image data files that are sent by the image control circuitry 185 to the image forming device 136. By this method the final image seen on the screen by the viewer will mask the irregularities of the screen.

By a similar method, the pixel-by-pixel correction described in the preceding paragraph can be applied to compensate for the intensity fall-off from center to corner that is common in projectors, or to compensate for any other non-uniformities in the projected image.

In the various disclosed embodiments, the same set of lenses 150 can be used as the projection lens and the camera lens, with a savings in volume, weight or parts cost compared to having separate lenses. In addition, projection lens systems may have higher optical quality and less aberration than camera lenses now used in some mobile devices such as cell phones, so combining the camera function with a projection function could lead to increased image quality from the camera.

The image forming device 136 and the detector array 180 need not, in general, have the same diagonal dimension. Nonetheless, the same lens system can be used both for projection and image capture, with the smaller element 136 or 180 effectively using only a portion of the lens. Alternatively, optical power can be added in the system to compensate for the dimensional difference between elements 136 and 180. That optical power could, for example, come from an added optical element between beam splitter 120 and either element 136 or 180. Alternatively, the optical power can be incorporated on the face of the PBS adjacent to either element 136 or 180.

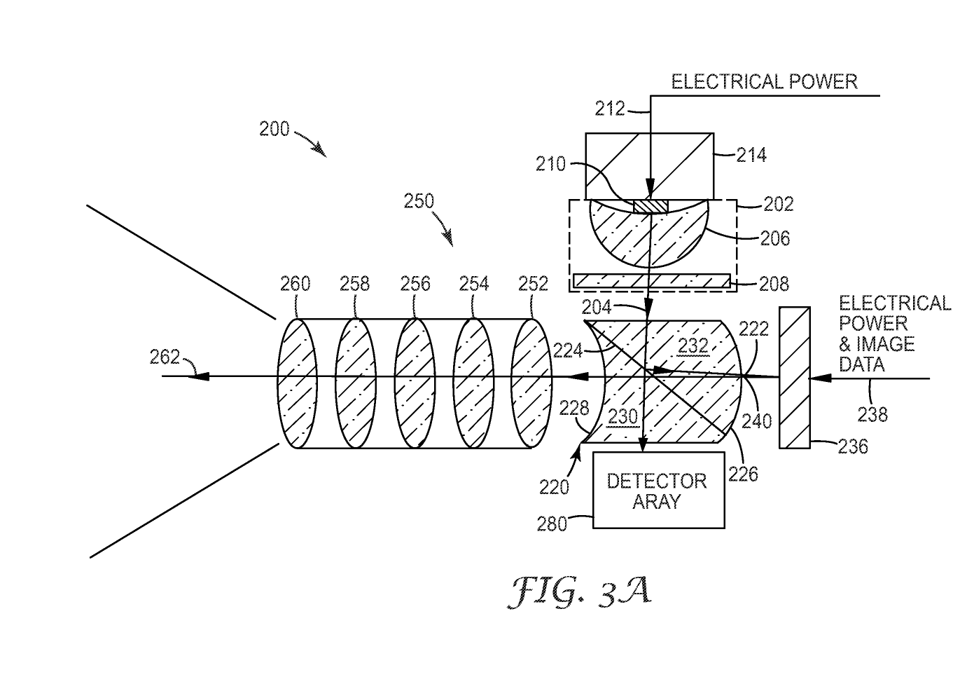

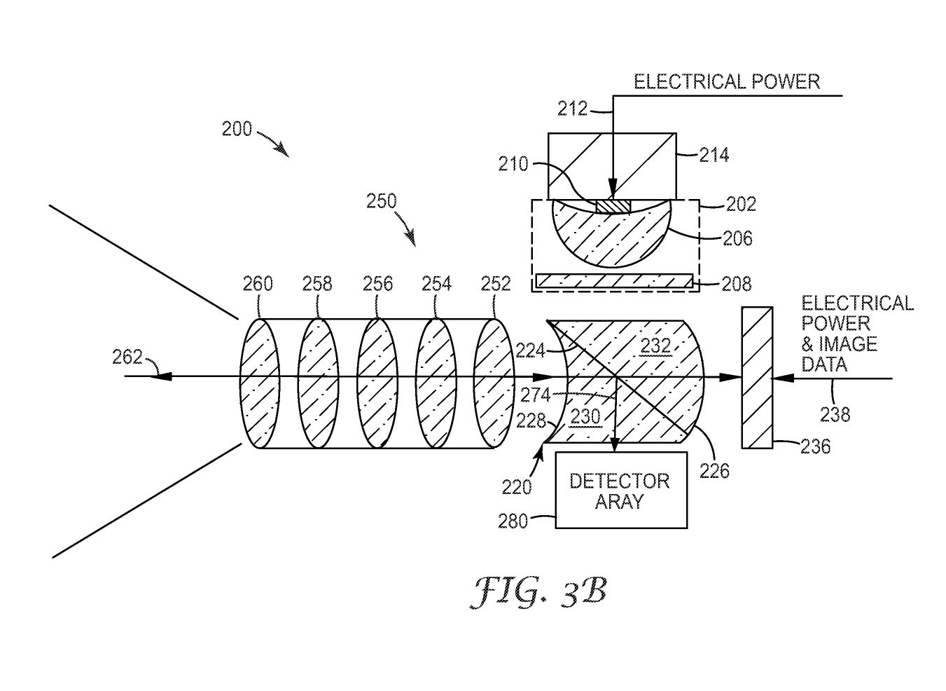

Referring now to FIGS. 3A and 3B, shown is a combination camera/projection subsystem 200 consistent with disclosed concepts and the above described embodiments, but showing other features by way of example. FIG. 3A illustrates the system in projection mode, and FIG. 3B illustrates the system in camera/image capture mode. The subsystem 200 is useful for projecting still or video images from miniature electronic systems such as cell phones, personal digital assistants (PDA's), global positioning system (GPS) receivers, and for capturing images. Subsystem 200 receives electrical power and image data from an electronic system (not illustrated in FIG. 2) into which it is embedded. Subsystem 200 is useful as a component part of a miniature projector accessory for displaying computer video. Subsystem 200 is useful in systems that are small enough to be carried, when not in use, in a pocket of clothing, such as a shirt pocket. Images projected by the subsystem 200 can be projected onto a reflective projection screen, a light-colored painted wall, a whiteboard or sheet of paper or other known projection surfaces. Subsystem 200 can be embedded, for example, in a portable computer such as a laptop computer or a cell phone.

Subsystem 200 comprises a light source 202 that provides a collimated light beam 204. The light source includes a collection lens 206, a collimator 208 and a solid state light emitter 210. According to one aspect, the collection lens 206 comprises a hyperhemispheric ball lens. According to one aspect, the hyperhemispheric ball lens is arranged as taught in US Patent Publication US 2007/0152231, the contents of which are hereby incorporated by reference.

The solid state light emitter 210 receives electrical power 212 with an electrical power level. The solid state emitter 210 thermally couples to a heat sink 214. The solid state light emitter provides an emitter light beam with an emitter luminous flux level. According to one aspect, the light beam 204 comprises incoherent light. According to another aspect the light beam 204 comprises illumination that is a partially focused image of the solid state light emitter 210. According to yet another aspect the solid state light emitter 210 comprises one or more light emitting diodes (LED's). According to another aspect, the collection lens 206 comprises a hemispheric ball lens. According to another aspect, the collimator 208 comprises a focusing unit comprising a first Fresnel lens having a first non-faceted side for receiving a first non-collimated beam and a first faceted side for emitting the collimated beam; and a second Fresnel lens having a second non faceted side for substantially directly receiving the collimated beam and second faceted side for emitting an output beam. According to another aspect the solid state light emitter 210 can be arranged as shown in U.S. patent application entitled “LED Mosaic” (Attorney Docket No. 62370US006), filed on even date herewith, and which is incorporated herein in its entirety. According to another aspect the light source 202 can be arranged as shown in U.S. patent application entitled “LED Source With Hollow Collection Lens” (Attorney Docket No. 62371US006), filed on even date herewith, and U.S. patent application entitled “Integrating Light Source Module” (Attorney Docket No. 62382US008), filed on even date herewith, both of which are incorporated by reference in their entirety.

In projection mode, the subsystem 200 comprises a refractive body 220. The refractive body 220 receives the light beam 204. The refractive body 220 provides a polarized beam 222. The refractive body 220 includes an internal polarizing filter 224. One polarized component of the light beam 204 is reflected by the internal polarizing filter 224 to form the polarized beam 222, and the other is transmitted toward detector array 280. According to one aspect, the light beam 204 is pre-polarized before reaching internal polarizing filter 224, so that the amount of light transmitted toward detector array 280 is minimized. According to one aspect, the refractive body is formed or utilized according to one or more aspects of US Patent Publication US 2007/0023941 A1 Duncan et al., US Patent Publication US 2007/0024981 A1 Duncan et al., US Patent Publication US 2007/0085973 A1 Duncan et al., and US Patent Publication US 2007/0030456 Duncan et al., all of which are hereby incorporated by reference in their entirety. The refractive body 220 comprises a first external lens surface 226 and a second external lens surface 228. According to one aspect, the external lens surfaces 226, 228 have curved lens surfaces and have non-zero lens power. According to another aspect, the external lens surface 226 comprises a convex lens surface that is useful in maintaining a small volume for the subsystem 200. According to another aspect, the external lens surfaces 226, 228 are flat. According to one aspect, the refractive body 220 comprises plastic resin material bodies 230, 232 on opposite sides of the internal polarizing filter 224. According to another aspect, the internal polarizing filter 224 comprises a multilayer optical film. According to another aspect, the refractive body 220 comprises a multifunction optical component that functions as a polarizing beam splitter as well as a lens. By combining the polarizing beam splitter and lens functions in a multifunction refractive body, losses that would otherwise occur at air interfaces between separate beam splitters and lenses are avoided.

The subsystem 200 comprises an image-forming device 236. The image-forming device 236 receives image data on electrical input bus 238. The image-forming device 236 receives the polarized beam 222. The image-forming device 236 selectively reflects the polarized beam 222 according to the image data. The image-forming device 236 provides an image 240 with a polarization that is rotated relative to the polarization of the polarized beam 222. The image-forming device 236 provides the image 240 to the refractive body 220. The image 240 passes through the internal polarizing filter 224. According to one aspect, the image-forming device 236 comprises a liquid crystal on silicon (LCOS) device.

The subsystem 200 comprises a projection lens assembly 250. The projection lens assembly 250 comprises multiple lenses indicated schematically at 252, 254, 256, 258, 260. The projection lens assembly 250 receives the image 240 from the refractive body 220. The projection lens assembly 250 provides an image projection beam 262 having a projected luminous flux that is suitable for viewing.

Referring now to FIG. 3B, shown is subsystem 200 in camera mode. In camera mode, projection lens assembly 250 receives light beam 272 forming a portion of an image to be captured. One polarized component of the light beam 272 is reflected by the internal polarizing filter 224 to form the polarized beam 274 directed toward detector array 280, and the other is transmitted toward image-forming device 236. Detector array 280 then provides an electrical output indicative of the image of which light beam 272 formed a portion of.

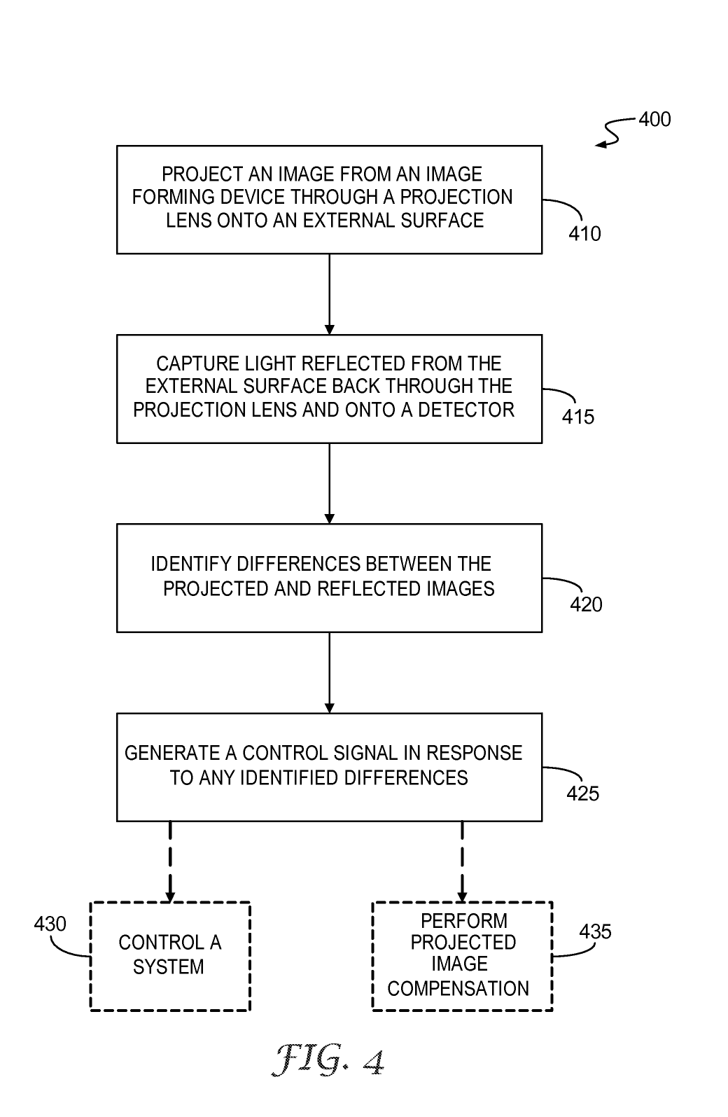

Referring again to the above-described methods of controlling any of the disclosed combination camera/projectors systems, or other like systems, a flow diagram 400 is provided in FIG. 4 illustrating such a method. This method of controlling an image projection system includes the step 410 of projecting an image from an image forming device (e.g., 136) through a projection lens (e.g., 150) onto an external surface. Then, as shown at step 415, the method includes capturing light reflected from the external surface back through the projection lens and onto a detector (e.g., 180). As shown at step 420, differences between the projected and reflected images are identified. Then, as shown at step 425 a control signal is generated in response to any identified differences.

The step 420 of identifying differences between the projected and reflected images can include the above-described concept of identifying a pointer (e.g., a laser pointer) location on the projected image. Generating the control signal can then optionally include generating the control signal in response to the identified pointer location to control a system, as shown at 430 in FIG. 4. The system controlled can be, for example, the projections system, a computer operating system (e.g., in which the projected image is used as a display and performs graphical user interface functions in this context), or any other system.

The method shown in FIG. 4 can also optionally include the step 435 of performing projected image compensation, in response to the control signal, to adjust for particular screen conditions. Examples of screen conditions such as color, contrast and luminance can be compensated for by controlling the projection system to change the projected image, the projected luminance, etc.

Unless otherwise indicated, all numbers expressing feature sizes, amounts, and physical properties used in the specification and claims are to be understood as being modified by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

Various modifications and alterations of this invention will be apparent to those skilled in the art without departing from the scope and spirit of this invention, and it should be understood that this invention is not limited to the illustrative embodiments set forth herein. All U.S. patents, patent application publications, and other patent and non-patent documents referred to herein are incorporated by reference in their entireties, except to the extent any subject matter therein is inconsistent with the foregoing disclosure.

What is claimed is:

1. A combination camera/projection system, comprising:
an image forming device;
a light source;
a projection lens;
a detector array; and
a beam splitter disposed to direct light from the light source to the image forming device, and from the image forming device to the projection lens, and from the projection lens to the detector array.

2. The system of claim 1, wherein the beam splitter is a polarizing beam splitter (PBS), and wherein the projection lens and PBS serve a dual purpose by projecting light corresponding to an image to be projected and receiving light corresponding to an image to be captured.

3. The system of claim 1, wherein the image to be captured is a surface to be found for auto-focusing the system.

4. The system of claim 1, wherein the projected image is either a still image or a motion video image.

5. The system of claim 2, wherein the image forming device is a liquid crystal on silicon (LCOS) device.

6. The system of claim 2, wherein the PBS receives light from the light source, and allows a first polarization state to pass through while reflecting a second polarization state to the image forming device, and the PBS allowing light reflected from the image forming device to pass though to the projection lens to be projected, and wherein the PBS receives light from an object external to the system and reflects that light to a camera comprising the detector array.

7. The system of claim 1, wherein the received light is a signal that is reflected to a sensor.

8. The system of claim 1, wherein the signal is used to auto focus the projection lens.

9. The system of claim 2, wherein the PBS includes at least one curved surface.

10. The system of claim 2, wherein the PBS includes a polymeric multilayer polarizing film.

11. The system of claim 2, wherein the PBS includes a MacNeille beam splitter comprising dielectric coatings.

12. The system of claim 2, wherein the PBS comprises a wire-grid polarizer.

13. The system of claim 2, wherein the PBS receives light from the light source, and allows a first polarization state to pass through to the image forming device while reflecting a second polarization state, and the PBS reflecting light reflected from the image forming device to the projection lens to be projected, and wherein the PBS receives light from an object external to the system and transmits that light to a camera comprising the detector array.

14. The system of claim 1, wherein the source is from a selection of light sources including laser cavity, an LED, an array of LEDs, or an LED including a microstructure such as a photonic crystal.

15. The system of claim 1, wherein the system is sized to fit within a cell phone.

16. The system of claim 1, and further comprising a quarter wave plate retarder between the photographic scene and the beam splitter to allow for improved image quality of an image to be captured.

17. The system of claim 1, wherein the beam splitter is a beam splitting plate, and wherein the projection lens and beam splitting plate serve a dual purpose by projecting light corresponding to an image to be projected and receiving light corresponding to an image to be captured.

18. The system of claim 1, and further comprising a polarizer positioned between the beam splitter and the detector array to protect the detector array from prolonged or intense exposure to residual light from the light source or to increase contrast of detected images entering the projection lens and reflecting off of the beam splitter.

19. A method of controlling an image projection system, the method comprising:
projecting an image from an image forming device through a projection lens onto an external surface;
capturing light reflected from the external surface back through the projection lens and onto a detector;
identifying differences between the projected and reflected images; and
generating a control signal in response to any identified differences.

20. The method of claim 19, wherein identifying differences between the projected and reflected images further comprises identifying a pointer location on the projected image, and wherein generating the control signal comprises generating the control signal in response to the identified pointer location to control a system.

21. The method of claim 19, and further comprising the step of performing projected image compensation, in response to the control signal, to adjust for particular screen conditions.

22. The method of claim 21, wherein the screen conditions include at least one of the group of color, contrast and luminance.
